(19) United States
(12) Patent Application Publication
(10) Pub. No.: US 2026/0222016 A1
(43) Pub. Date: Jul. 30, 2026

(54) METHOD AND DEVICE FOR MULTI-GROUP MULTICASTING IN WIRELESS COMMUNICATION SYSTEM

(71) Applicants: LG ELECTRONICS INC., Seoul (KR); KOREA ADVANCED INSTITUTE OF SCIENCE AND TECHNOLOGY, Daejeon (KR)

(72) Inventors: Jaeky OH, Seoul (KR); Junil CHOI, Seoul (KR); Hyeongtaek LEE, Seoul (KR); Jaehoon CHUNG, Seoul (KR)

(73) Assignee: LG ELECTRONICS INC., Seoul (KR)

(21) Appl. No.: 19/148,284

(22) PCT Filed: Jan. 16, 2023
(86) PCT No.: PCT/KR2023/000724

§ 371 Date: Jul. 15, 2025

(51) Int. Cl. H04B 7/04; H04W 72/044

(52) U.S. Cl. CPC H04B 7/04013; H04W 72/046

(57) ABSTRACT

The present disclosure is for multi-group multicasting in a wireless communication system. An operation method of a user equipment (UE) comprises the steps of: receiving at least one reference signal from a base station; transmitting, to the base station, feedback information based on the at least one reference signal; and receiving downlink data from the base station, wherein the downlink data is transmitted on the basis of a spatial domain transmission filter, is reflected by a first reconfigurable intelligent surface (RIS) among a plurality of RISs, and then received by the UE, and the plurality of RISs may each assist the signal transferring of each of a plurality of groups including a plurality of UEs.

### CROSS-REFERENCE TO RELATED APPLICATION(S)

This application is the National Stage filing under 35 U.S.C. 371 of International Application No. PCT/KR2023/000724, filed on Jan. 16, 2023, the contents of which are all incorporated by reference herein in its entirety.

### TECHNICAL FIELD

The following description relates to a wireless communication system, and more particularly, the following description relates to an apparatus and method for multi-group multicast in the wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide an apparatus and method for performing multi-group multicast in a wireless communication system.

The present disclosure may provide an apparatus and method for performing multi-group multicast using a Reconfigurable Intelligent Surface (RIS) in a wireless communication system.

The present disclosure may provide an apparatus and method for effectively performing multi-group multicast using a plurality of RISs in a wireless communication system.

The present disclosure may provide an apparatus and method for performing active beamforming to mitigate inter-group interference in multi-group multicast using a plurality of RISs in a wireless communication system.

The present disclosure may provide an apparatus and method for estimating representative channels for each group in multi-group multicast using a plurality of RISs in a wireless communication system.

The present disclosure may provide an apparatus and method for estimating representative channels based on average channel values of UEs within a group in multi-group multicast using a plurality of RISs in a wireless communication system.

The present disclosure may provide an apparatus and method for a base station to perform active beamforming based on representative channels of each group in a wireless communication system.

The present disclosure may provide an apparatus and method for configuring reflection coefficients of passive elements of a plurality of RISs in a wireless communication system.

The present disclosure may provide an apparatus and method for estimating phase shift values of RIS passive elements to minimize the attenuation of intended signals for UEs within each group in a wireless communication system.

The present disclosure may provide an apparatus and method for configuring reflection coefficients of passive elements of a plurality of RISs based on an active beamformer represented by channel vectors derived using a Neumann Series (NS) technique in a wireless communication system.

The technical objectives of the present disclosure are not limited to the aforementioned aspects, and other technical objectives not explicitly mentioned may be recognized by those skilled in the relevant art from the embodiments of the present disclosure described below.

According to an embodiment of the present disclosure, a method for operating a user equipment (UE) in a wireless communication system, the method may include: receiving, from a base station, at least one reference signal; transmitting, to the base station, feedback information based on the at least one reference signal; and receiving, from the base station, downlink data, wherein the downlink data is transmitted based on a spatial domain transmission filter, and received by the UE after being reflected by a first Reconfigurable Intelligent Surface (RIS) among a plurality of RISs, wherein each of the plurality of RISs assists signal transmission of each of a plurality of groups including a plurality of UEs.

According to an embodiment of the present disclosure, a method for operating a base station in a wireless communication system, the method may include: transmitting, to at least one user equipment (UE), at least one reference signal; receiving, from the at least one UE, feedback information based on the at least one reference signal; and transmitting, to the at least one UE, downlink data, wherein the downlink data is transmitted based on a spatial domain transmission filter, and received by the at least one UE after being reflected by a first Reconfigurable Intelligent Surface (RIS) among a plurality of RISs, wherein each of the plurality of RISs assists signal transmission of each of a plurality of groups including a plurality of UEs.

According to an embodiment of the present disclosure, a user equipment (UE) in a wireless communication system, the UE may include: a transceiver; and a processor connected to the transceiver, wherein the processor is configured to perform operations may include: receiving, from a base station, at least one reference signal; transmitting, to the base station, feedback information based on the at least one reference signal; and receiving, from the base station, downlink data, wherein the downlink data is transmitted based on a spatial domain transmission filter, and received by the UE after being reflected by a first Reconfigurable Intelligent Surface (RIS) among a plurality of RISs, wherein each of the plurality of RISs assists signal transmission of each of a plurality of groups including a plurality of UEs.

According to an embodiment of the present disclosure, a base station in a wireless communication system, the base station may include: a transceiver; and a processor connected to the transceiver, wherein the processor is configured to perform operations may include: transmitting, to at least one user equipment (UE), at least one reference signal; receiving, from the at least one UE, feedback information based on the at least one reference signal; and transmitting, to the at least one UE, downlink data, wherein the downlink data is transmitted based on a spatial domain transmission filter, and received by the at least one UE after being reflected by a first Reconfigurable Intelligent Surface (RIS) among a plurality of RISs, wherein each of the plurality of RISs assists signal transmission of each of a plurality of groups including a plurality of UEs. According to an embodiment of the present disclosure, a communication device may include: at least one processor; a processor connected to the transceiver, at least one computer memory connected to the at least one processor and storing instructions that, based on being executed by the at least one processor, cause the device to perform operations, wherein the operations may include: receiving, from a base station, at least one reference signal; transmitting, to the base station, feedback information based on the at least one reference signal; and receiving, from the base station, downlink data, wherein the downlink data is transmitted based on a spatial domain transmission filter, and received by the UE after being reflected by a first Reconfigurable Intelligent Surface (RIS) among a plurality of RISs, wherein each of the plurality of RISs assists signal transmission of each of a plurality of groups including a plurality of UEs.

According to an embodiment of the present disclosure, a non-transitory computer-readable medium storing at least one instruction, comprising the at least one instruction being executable by a processor, wherein the at least one instruction is configured to perform operations may include: receiving, from a base station, at least one reference signal; transmitting, to the base station, feedback information based on the at least one reference signal; and receiving, from the base station, downlink data, wherein the downlink data is transmitted based on a spatial domain transmission filter, and received by the UE after being reflected by a first Reconfigurable Intelligent Surface (RIS) among a plurality of RISs, wherein each of the plurality of RISs assists signal transmission of each of a plurality of groups including a plurality of UEs.

As is apparent from the above description, the embodiments of the present disclosure have the following effects.

According to the present disclosure, in a multi-group multicast environment, interference among groups can be mitigated, while minimizing attenuation of the intended signals for UEs within each group.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 shows an example of a wireless communication system using a plurality of RISs according to an embodiment of the present disclosure.

FIG. 12 shows a signal flow between a UE and a base station for transmitting and receiving data according to an embodiment of the present disclosure.

FIG. 13 shows an example of a procedure for receiving data at a UE according to an embodiment of the present disclosure.

FIG. 14 shows an example of a procedure for transmitting data from a base station according to an embodiment of the present disclosure.

FIG. 15 shows an example of configuring a beamformer and RIS reflection coefficients at a base station according to an embodiment of the present disclosure.

FIG. 16 shows an example of a simulation environment showing positions of a base station, RISs, and UEs according to an embodiment of the present disclosure.

FIG. 17 shows a performance graph showing the sum of UE data rates according to downlink transmit power values at the base station according to an embodiment of the present disclosure.

FIG. 18 shows a cumulative distribution function graph of minimum UE data rates according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

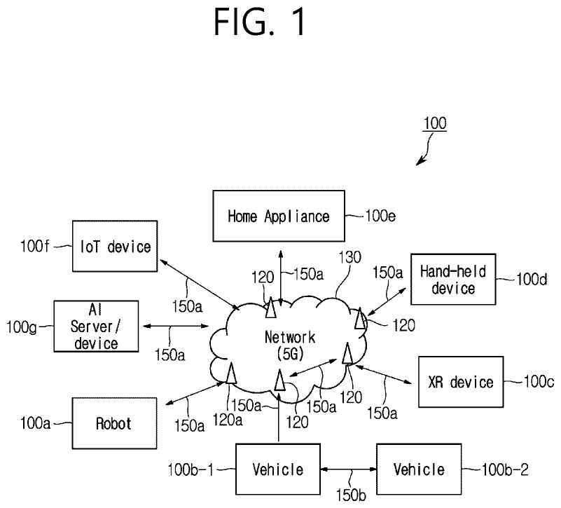

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

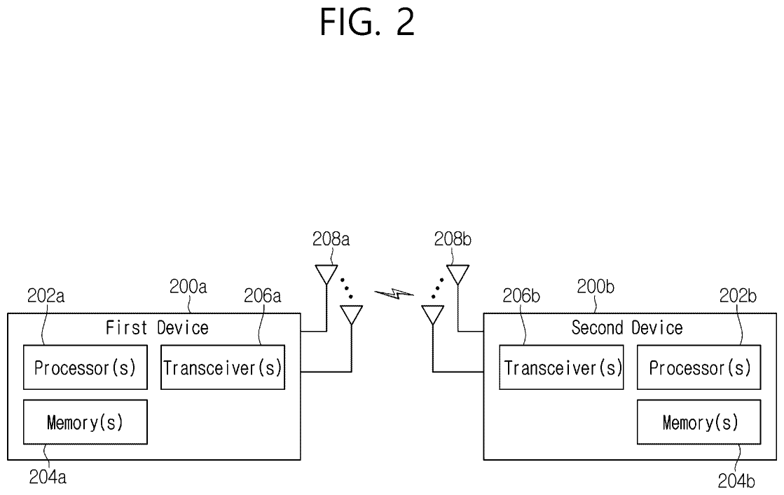

FIG. 2 shows an example of a wireless device applicable to the present disclosure.

Referring to FIG. 2, a first wireless device 200a and a second wireless device 200b may transmit and receive radio signals through various radio access technologies (e.g., LTE or NR). Here, (the first wireless device 200a, the second wireless device 200b) may correspond to (the wireless device 100x, the base station 120) and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

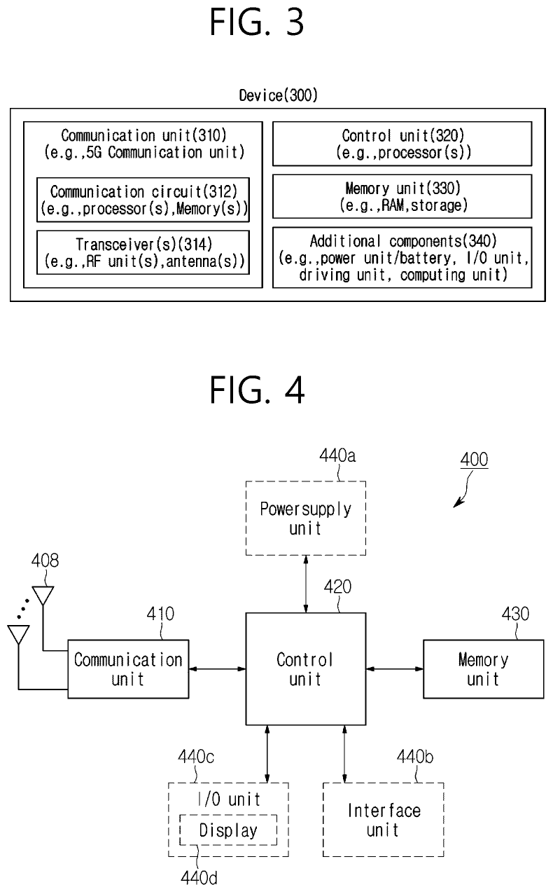

FIG. 3 shows another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

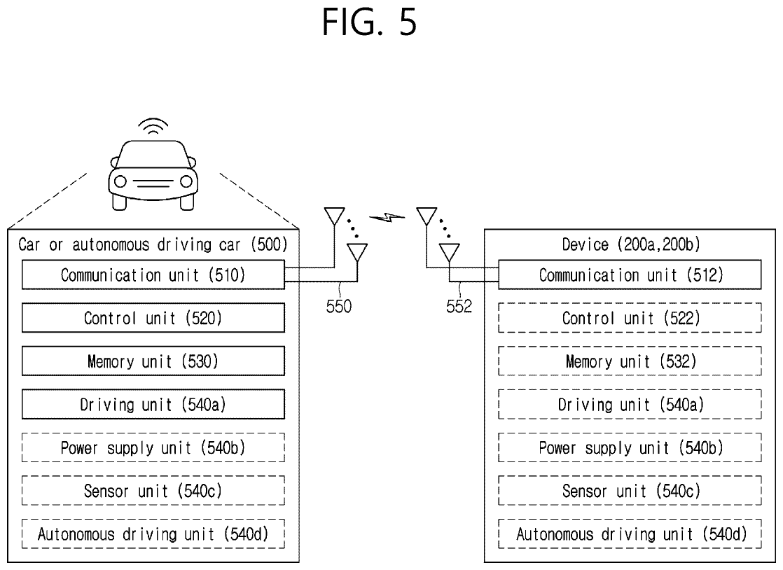

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

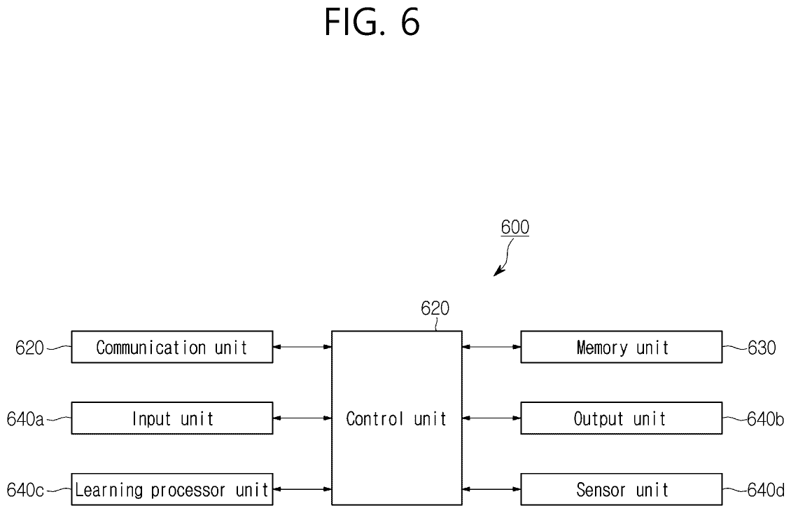

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

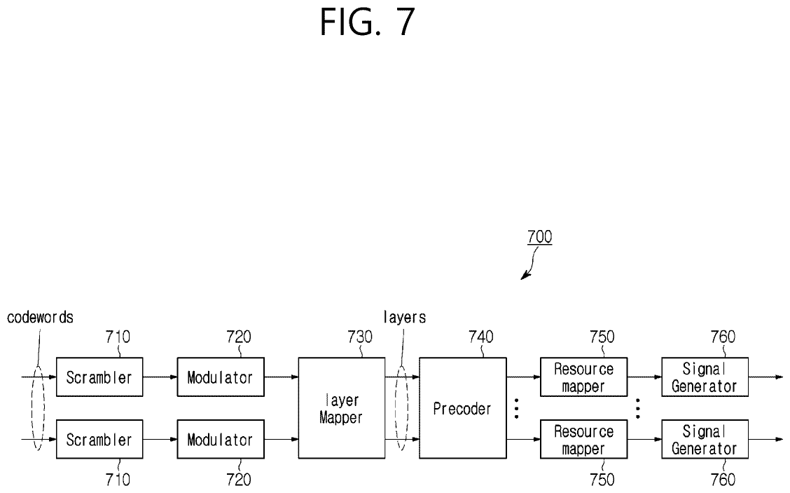

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |
| Mobility support | Up to 1000 | km/hr |

| | |
|---|---|
| Satellite integration | Fully |
| AI | Fully |
| Autonomous vehicle | Fully |
| XR | Fully |
| Haptic Communication | Fully |

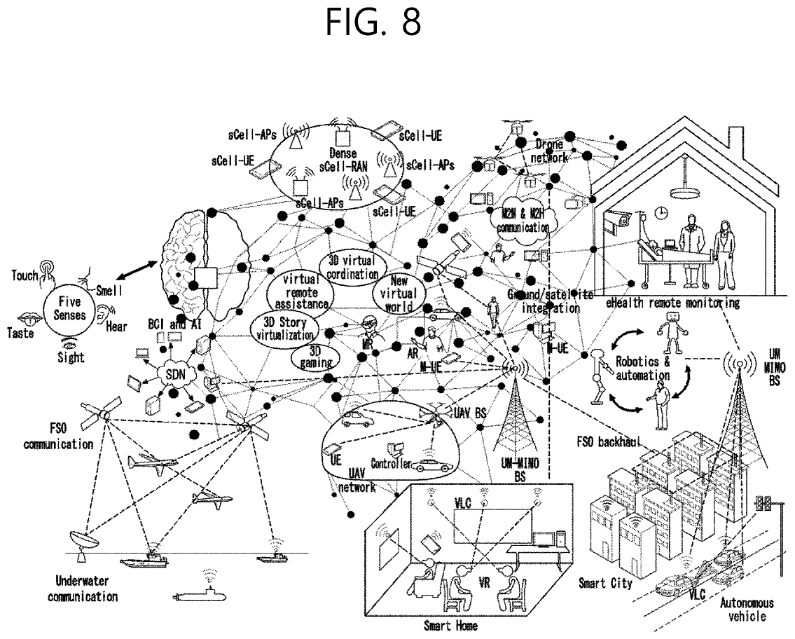

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security. FIG. 8 shows an example of a communication structure providable in a 6G system applicable to the present disclosure. Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System-Terahertz (THz) Communication

THz communication is applicable to the 6G system. For example, a data rate may increase by increasing bandwidth. This may be performed by using sub-THz communication with wide bandwidth and applying advanced massive MIMO technology.

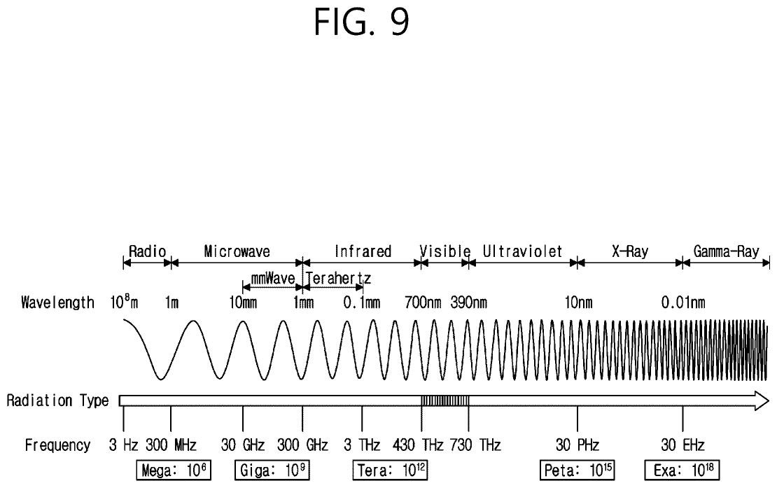

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

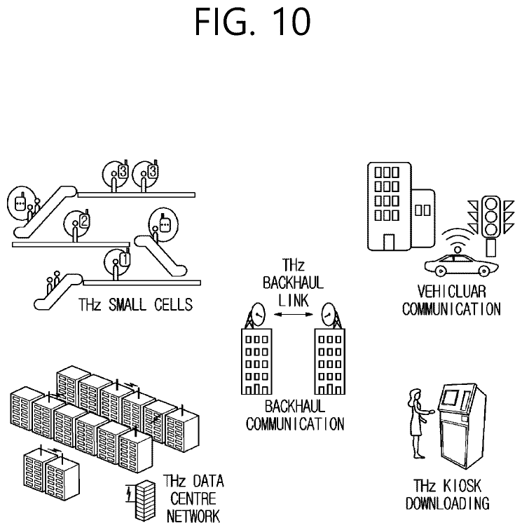

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Reflecting Intelligent Surface (RIS)

RIS is one of the major candidate technologies for future wireless communications, comprising a surface equipped with multiple reflective elements for signals. Each element can independently change the phase of the incident electromagnetic wave. One of the main features of RIS is controllability, enabling real-time adjustment of phase shifts for each element. Based on controlling the phase shifts, it is possible to dynamically modify wireless communication channels in real-time, such as improving information transfer rates or assisting devices unable to receive signals. Further, since RIS uses passive elements that only reflect signals, it can be implemented with low cost and low power consumption.

Metamaterials, which are elements responsible for reflecting signals, can be implemented in various ways. For example, metamaterials can be implemented using diode-based metallic materials, liquid crystals, or graphene-based methods (e.g., graphene-metal hybrid methods utilizing Surface Plasmon Polariton (SPP)). Metamaterials can also be realized by various other methods. Elements composed of metamaterials can be controlled by a controller. The controller can adjust the phase shifts applied when signals are reflected at each element by individually controlling each element. For example, a base station or a separate device may function as the controller.

In some cases, RIS may further include active elements in addition to passive elements. Active elements refer to elements capable of processing received signals beyond simply reflecting signals. Active elements can be implemented by connecting received RF chains to passive elements. Although active elements may weaken the advantages of RIS, such as low cost and low complexity, they enable more diverse and flexible system operations. Active elements are sometimes referred to as active sensors.

### Specific Embodiments of the Present Disclosure

The present disclosure relates to an apparatus and method for performing multi-group multicast in a wireless communication system. Specifically, the present disclosure describes techniques for performing multi-group multicast using reconfigurable intelligent surfaces (RISs) in a wireless communication system. In the following description, a reconfigurable intelligent surface may include a reflecting intelligent surface referring to a device that reflects signals using multiple elements.

RIS is receiving attention as a promising technology to enhance communication performance in post-5G communications. An RIS consists of passive elements capable of adjusting phase shifts. Thus, a communication system utilizing RIS may enhance communication performance with relatively low cost and power consumption compared to conventional multi-antenna systems, which include active elements such as radio frequency chains.

A multi-group multicast method is based on the reuse of wireless communication resources. In a system supporting the multi-group multicast method, a base station simultaneously transmits the same data to UEs belonging to each group, and transmits different data to UEs belonging to different groups. The multi-group multicast method effectively alleviates the burden of massive wireless data traffic, reducing multi-transmission delay, energy consumption, and hardware complexity. Thus, the multi-group multicast method may be utilized when many users receive the same data, such as broadcasting popular TV programs.

Existing studies on multi-group multicast have only considered a single RIS. Thus, it is very difficult and complex to reflect different wireless channel environments for each group through the operation of a single RIS.

Accordingly, there is a need for RIS utilization techniques that reflect different wireless channel environments for each group while maintaining low complexity. Therefore, the present disclosure will describe techniques for performing multi-group multicast through beamforming considering a plurality of RISs in a wireless communication system. In the present disclosure, beamforming may include active beamforming at a base station and passive beamforming at an RIS. Passive beamforming may refer to controlling configuration values of passive elements of RISs. In the present disclosure, beamforming refers to forming a directional beam, and a beam may refer to a signal formed to have directivity using multiple antenna elements, or weights or filters used to form signals having directivity. In the present disclosure, a beam may also be referred to as a spatial domain filter, spatial domain transmission filter, spatial domain reception filter, or other terms having equivalent technical meanings.

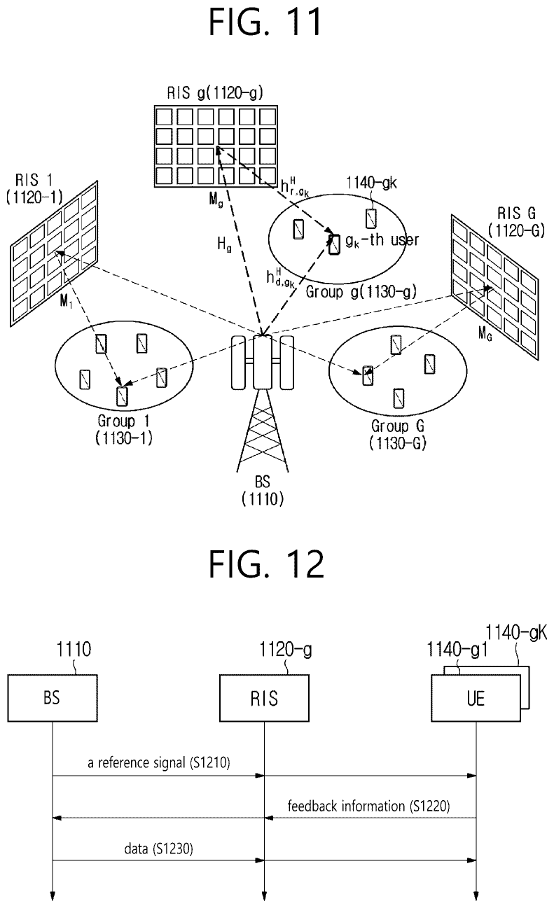

FIG. 11 shows an example of a wireless communication system using a plurality of RISs according to an embodiment of the present disclosure.

Referring to FIG. 11, the wireless communication system may include a base station (BS) (1110), a plurality of RISs (RIS 1, RIS g, RIS G) (1120-1, 1120-g, 1120-G), and a plurality of groups (Group 1, Group g, Group G) (1130-1, 1130-g, 1130-G). Each of the plurality of groups may include multiple UEs.

The base station (1110) transmits the same signal to UEs within a single group, and transmits different signals to UEs belonging to different groups. Since UEs within a single group receive the same signal, intra-group interference does not exist.

Each of the plurality of RISs (RIS 1, RIS g, RIS G) (1120-1, 1120-g, 1120-G) may include multiple passive elements that reflect signals, assisting signal transmission between the base station and UEs of a designated group. For example, RIS 1 (1120-1) may assist signal transmission between Group 1 (1130-1), which includes UEs located in an area adjacent to RIS 1 (1120-1), and the base station (1110), and RIS g (1120-g) may assist signal transmission between Group g (1130-g), which includes UEs located in an area adjacent to RIS g (1120-g), and the base station (1110). Each of the plurality of RISs (RIS 1, RIS g, RIS G) (1120-1, 1120-g, 1120-G) may be positioned to be spaced apart from each other by at least a first predetermined distance, and each of the plurality of groups (Group 1, Group g, Group G) (1130-1, 1130-g, 1130-G) may be spaced apart from each other by at least a second predetermined distance. The first predetermined distance and the second predetermined distance may be identical or different.

In the present disclosure, it is assumed that each UE may ignore signals reflected from RISs assisting signal transmission for other groups. For example, it is assumed that the k-th UE (1140-gk) of Group g (1130-g) may ignore signals reflected from RISs (RIS 1, RIS G) (1120-1, 1120-G) other than RIS g (1120-g), which assists the signal transmission for Group g (1130-g). This is because the k-th UE (1140-gk) of Group g (1130-g) is located sufficiently far from other RISs (RIS 1, RIS G) (1120-1, 1120-G), and thus the path loss of signals reflected from these RISs is expected to be large. Hereinafter, the k-th UE (1140-gk) of Group g (1130-g) may be referred to as the gₖ-th UE.

In the mathematical expressions used to describe embodiments of the present disclosure below, column vectors and matrices are denoted by boldface letters. Additionally, the transpose and Hermitian transpose of column vectors and/or matrices are denoted by (.)\hat{ }T and (.)\hat{ }H, respectively. The set of complex matrices of size a×b is denoted by C\hat{ }(a×b), and a diagonal matrix having elements of vector a as diagonal elements is denoted by diag(a). The p-norm of vector a is denoted by |a∥_p, the phase of each element in vector a is denoted by angle(a), and the absolute value of scalar a is denoted by |a|.

In the above-described environment, the downlink received signal of the gₖ-th UE may be expressed as in [Equation 1] below.

$${y\_g}_{k} = ( h\_d , {g}_{k} \hat{} H + h\_r , {g}_{k} \hat{} H * Φ\_g * H\_g ) * \sum \_g = 1 \hat{} G ( f\_g * s\_g ) + {n\_g}_{k} \qquad [ Equation 1 ]$$

In [Equation 1], y_gₖ is the downlink received signal at the gk-th UE, h_gₖ is the channel between the gₖ-th UE and the base station, h_gₖ\hat{ }H is the Hermitian transpose of h_gₖ, r_gₖ is the channel between the gₖ-th UE and the g-th RIS, r_gₖ\hat{ }H is the Hermitian transpose of r_gₖ, Φ_g is a passive beamformer representing the RIS element configuration matrix for the g-th group, H_g is the channel between the g-th RIS and the base station, f_g is the active beamformer corresponding to the g-th group, s_g is the transmit signal for the g-th group, G is the total number of groups, n_gₖ represents the received noise at the gₖ-th UE.

The matrix F including active beamformers corresponding to each group in [Equation 1] may be expressed as F=[f_1, . . . , f_G] E C\hat{ }(N×G), the matrix F may satisfy the power constraint condition Tr (FHF)≤PT. PT denotes the total transmit power value at the base station. Additionally, the transmit signal sg for the g-th group satisfies E[|sg|\hat{ }2]=1. Additionally, the RIS element configuration matrix Φ_{g} for the g-th group may be expressed as Φ_{g}=diag(φ_{g}). diag (φ_{g}) denotes a diagonal matrix with elements of Φg as diagonal components. Og represents the phase shift values of passive RIS elements for the g-th group, which may be expressed as Φ_{g}=[e\vec{ }(j·θ_g,1), . . . , e\hat{ }(j·θ_g,M_{g})]\hat{ }T.

In [Equation 1], the received noise may be represented as n_gₖ~CN(0, σ²_gₖ), σ² denotes the noise variance of the gₖ-th UE, CN(0, σ²_gₖ) denotes a multivariate normal distribution with mean mu and covariance σ². gₖ denotes the index of the UE and may be expressed as gₖ=Σ_{g′=1}\hat{ }{g−1} K_g′+k, where k may range from 1 to K_g. Here, K_g denotes the number of UEs belonging to the g-th group. Therefore, the total number of UEs across all groups may be expressed as K=>_{g−1} {G} K_g.

In the case of multi-group multicast, the same signal is transmitted to UEs belonging to one group, so there is no intra-group interference. However, since different signals are transmitted to UEs belonging to different groups, inter-group interference exists. Thus, in order to effectively perform multi-group multicast, beamforming to mitigate inter-group interference needs to be performed. Conventionally, as a beamforming method for mitigating inter-group interference, a singular value decomposition (SVD)-based block diagonalization method has been provided. However, the SVD-based block diagonalization method has a problem in that the complexity rapidly increases as the number of antennas at the base station or the number of UEs increases, because complicated SVD calculations must be performed to determine the beamformers for all groups.

Therefore, in the embodiments of the present disclosure, a representative channel for each group is estimated, and inter-group interference may be mitigated by performing zero forcing (ZF) beamforming based on the representative channel.

When the downlink received signal of the gₖ-th UE is expressed as in [Equation 1], the representative channel of the g-th group may be expressed as shown in [Equation 2] below.

$$\begin{matrix}h \sim \_g \hat{} H = \begin{matrix}( 1 / K\_g ) * \sum \_ \{ k = 1 \} \hat{} \{ K\_g \} \\ ( h\_d , {g}_{k} \hat{} H + h\_r , {g}_{k} \hat{} H * Φ\_g * H\_g )\end{matrix} \\ = \begin{matrix}( 1 / K\_g ) * ( \sum \_ \{ k = 1 \} \hat{} \{ K\_g \} h\_d , {g}_{k} \hat{} H + \\ \sum \_ \{ k = 1 \} \hat{} \{ K\_g \} h\_r , {g}_{k} \hat{} H * Φ\_g * H\_g )\end{matrix} \\ = h \sim \_d , g \hat{} H + h \sim \_r , g \hat{} H * Φ\_g * H\_g\end{matrix} \qquad [ Equation 2 ]$$

In [Equation 2], h~g\hat{ }H denotes the representative channel of the g-th group. Since other parameters of [Equation 2] are the same as those defined in [Equation 1] and the aforementioned description, definitions and/or explanations thereof will be omitted. Additionally, in the following descriptions of [Equation 3] to [Equation 17], definitions and/or explanations for parameters already defined in the present disclosure will be omitted.

In [Equation 2], it is shown that the average channel value of UEs belonging to the g-th group is used as the representative channel of the g-th group, but this is merely an example, and the representative channel according to embodiments of the present disclosure is not limited thereto.

Assuming that the representative channel expressed as in [Equation 2] may effectively represent the channels of UEs within the corresponding group, inter-group interference may be mitigated by utilizing ZF beamforming based on the representative channel. The ZF beamformer at the base station may be expressed as shown in [Equation 3] below.

$$F = H ∼ * ( H ∼ \hat{} H * H ∼ ) \hat{} ( - 1 ) * P \hat{} ( 1 / 2 ) = [ f\_ 1 , … , f\_G ] \qquad [ Equation 3 ]$$

In [Equation 3], F denotes the matrix including ZF beamformers for all groups, and H~ denotes the matrix including representative channels for all groups. H~\hat{ }H may be expressed as H~=[h~_1, . . . , h~_G]∈C\hat{ }(N×G). (H~)\hat{ }H denotes the Hermitian transpose of H~. Here, P is a matrix related to the transmit power at the base station, which may be expressed as [Equation 4] below.

$$p = diag ( [ p\_ 1 , … , p\_G ] \hat{} T ) \qquad [ Equation 4 ]$$

In [Equation 4], the sum of diagonal elements of P corresponds to the total transmit power value PT at the base station. diag(a) denotes a diagonal matrix having elements of a as its diagonal elements, and [a]\hat{ }T denotes the transpose of a.

By performing ZF beamforming as in [Equation 3], the base station may mitigate inter-group interference. However, ZF beamforming has the disadvantage of reducing the strength of the intended signal. Therefore, in the embodiments of the present disclosure, passive beamforming may be performed through RISs for each group, minimizing the reduction in the strength of the intended signal for each group. Hereinafter, a method for deriving the RIS element configuration matrix that minimizes attenuation of the intended signal for each group, for passive beamforming, will be described.

Since the ZF beamformer involves inverse matrix operations, it is generally very difficult to express signal loss using channel vectors. Thus, the value of the ZF beamformer may be expressed in terms of channel vectors based on the Neumann Series (NS) method, which transforms inverse matrix operations into multiplications and additions between matrices.

To utilize the NS method, a new matrix R as shown in [Equation 5] below may be defined from the ZF beamformer expressed in [Equation 3].

$$R = ( H ∼ \hat{} H * H ∼ ) / N \qquad [ Equation 5 ]$$

In [Equation 5], H~ denotes the matrix including representative channels for all groups, (H~)\hat{ }H denotes the Hermitian transpose of H~, and N denotes the number of antennas at the base station.

Using the NS method, the inverse of matrix R may be expressed as shown in [Equation 6] below.

$$R \hat{} ( - 1 ) = Σ\_ \{ n = 0 \} \hat{} \{ ∞ \} ( - D \hat{} ( - 1 ) * E ) \hat{} n * D \hat{} ( - 1 ) \qquad [ Equation 6 ]$$

In [Equation 6], R\hat{ }(−1) denotes the inverse matrix of R, D denotes the precondition matrix, and E denotes R-D.

In [Equation 6], the inverse matrix operation has been expressed using only matrix multiplications and additions through the NS method, but it includes an infinite summation. Therefore, in the embodiments of the present disclosure, the inverse of R may be approximated as shown in [Equation 7] below.

$$R \hat{} ( - 1 ) \approx Σ\_ \{ n = 0 \} \hat{} \{ L \} ( - D \hat{} ( - 1 ) * E ) \hat{} n * D \hat{} ( - 1 ) \qquad [ Equation 7 ]$$

Referring to [Equation 6] and [Equation 7], it may be observed that as the value of L increases, a more accurate approximation of the inverse matrix of R is possible, but the complexity also increases. Therefore, in the embodiments of the present disclosure, it is assumed that the value of L is 1 (L=1). When L is 1, the approximated ZF beamformer may be expressed as shown in [Equation 8].

$$F = ( 1 / N ) * H \sim * ( 2 * D \hat{} ( - 1 ) - D \hat{} ( - 1 ) * R * D \hat{} ( - 1 ) ) * P \hat{} ( 1 / 2 ) \qquad [ Equation 8 ]$$

In [Equation 8], F denotes the matrix including ZF beamformers for all groups.

Referring to [Equation 8], it may be seen that the performance of the ZF beamformer expressed using the NS method is determined by the precondition matrix D. The precondition matrix D may be expressed D=diag_0(R) by employing the diagonal NS method. The diagonal NS method refers to a method of constructing a new diagonal matrix from the diagonal elements of the matrix R for which the inverse matrix is desired.

When the precondition matrix D is expressed as D=diag_0(R), the ZF beamformer may be expressed as F_D=(1/N)*H~*(2*(diag_0(R))\hat{ }(−1)−(diag_0(R))\hat{ }(−1)*R*(diag_0(R))\hat{ }(−1))*P\hat{ }(½). In this case, the beamformer for the g-th group may be expressed as shown in [Equation 9] below.

$$f\_g = √ ( p\_g ) * ( ( h \sim \_g / ‖ h \sim \_g ‖ \hat{} 2 ) = Σ\_ \{ i = 1 , i \neq g \} \hat{} \{ G \} [ h \sim \_i * ( h \sim \_i \hat{} H * h \sim \_g ) / ( ‖ h \sim \_i ‖ \hat{} 2 * ‖ h \sim \_g ‖ \hat{} 2 ) ] ) \qquad [ Equation 9 ]$$

In [Equation 9], f_g denotes the beamformer for the g-th group, p_g denotes the transmit power from the base station to the g-th group, h~g denotes the representative channel of the g-th group, and h~ i denotes the representative channel of the i-th group.

Referring to [Equation 9], it may be seen that attenuation of the intended signal for the g-th group occurs due to the beamformer of the g-th group, and the amount of intended signal attenuation for the gr-th UE within the g-th group may be expressed as shown in [Equation 10] below.

$$√ ( p\_g ) * ( h\_d , {g}_{k} \hat{} H + h\_r , gk \hat{} H * Φ\_g * H\_g ) * ( Σ\_ \{ i = 1 , i \neq g \} \hat{} \{ G \} [ h \sim \_i * ( h \sim \_i \hat{} H * h \sim \_g ) / ( ‖ h \sim \_i ‖ \hat{} 2 * ‖ h \sim \_g ‖ \hat{} 2 ) ] ) \qquad [ Equation 10 ]$$

Due to the attenuation of the intended signal as shown in [Equation 10], the signal-to-interference-and-noise ratio (SINR) of each UE is reduced, which may lead to a decrease in data transmission rate.

Therefore, in embodiments of the present disclosure, the RIS element configuration matrix minimizing attenuation of the intended signal for UEs within each group may be obtained, and values of the RIS passive elements may be configured according to the obtained RIS element configuration matrix.

The method of finding the g-th RIS element configuration matrix that minimizes the attenuation of the intended signal for UEs in the g-th group may be expressed as shown in [Equation 11] below.

$$( P 1 ) : min\_ ( Φ\_g ) √ ( p\_g ) * Σ\_ \{ k = 1 \} \hat{} \{ K\_g \} ( h\_d , {g}_{k} \hat{} H + h\_r , {g}_{k} \hat{} H * Φ\_g * H\_g ) * ( Σ\_ \{ i = 1 , i \neq g \} \hat{} \{ G \} [ h \sim \_i * ( h \sim \_i \hat{} H * h \sim \_g ) / ( ‖ h \sim \_i ‖ \hat{} 2 * ‖ h \sim \_g ‖ \hat{} 2 ) ] ) \qquad [ Equation 11 ]$$

By rearranging [Equation 11] using [Equation 2], which defines the representative channel of the g-th group, it may be expressed as shown in [Equation 12] below.

$$√ ( p\_g ) * Σ\_ \{ k = 1 \} \hat{} \{ K\_g \} ( h\_d , {g}_{k} \hat{} H + h\_r , {g}_{k} \hat{} H * Φ\_g * H\_g ) * ( Σ\_ \{ i = 1 , i \neq g \} \hat{} \{ G \} [ h \sim \_i * ( h \sim \_i \hat{} H * h \sim \_g ) / ( ‖ h \sim \_i ‖ \hat{} 2 * ‖ h \sim \_g ‖ \hat{} 2 ) ] ) = - √ ( p\_g ) * K\_g * h \sim \_g \hat{} H * ( Σ\_ \{ i = 1 , i \neq g \} \hat{} \{ G \} [ h \sim \_i * ( h \sim \_i \hat{} H * h \sim \_g ) / ( ‖ h \sim \_i ‖ \hat{} 2 * ‖ h \sim \_g ‖ \hat{} 2 ) ] ) = - √ ( p\_g ) * K\_g * Σ\_ \{ i = 1 , i \neq g \} \hat{} \{ G \} [ ( h \sim \_i \hat{} H * h \sim \_g ) \hat{} 2 / ( ‖ h \sim \_i ‖ \hat{} 2 * ‖ h \sim \_g ‖ \hat{} 2 ) ] = √ ( p\_g ) * K\_g * [ h \sim \_g \hat{} H * ( Σ\_ \{ i = 1 , i \neq g \} \hat{} \{ G \} ( h \sim \_i / ‖ h \sim \_i ‖ ) * ( h \sim \_i \hat{} H / ‖ h \sim \_i ‖ ) ) * h \sim \_g ] / ‖ h \sim \_g ‖ \hat{} 2 \qquad [ Equation 12 ]$$

To gain intuition for the optimal Φ_g that minimizes [Equation 12], the optimization variable in [Equation 11] may be replaced by the term changed by Φ_g, which is h~g. Thus, the method for finding the g-th RIS element configuration matrix may be expressed as shown in [Equation 13] below.

$$( P {1}^{′} ) \text{:} min\_ \text{} \{ h \sim \_g \} [ \text{} {( h \sim \_g )}^{⋀} H * ( Σ\_ {\{ i = 1 , i \neq g \}}^{⋀} \{ G \} ( h \sim \_i / ‖ h \sim \_i ‖ ) * ( ( h \sim {\_i}^{⋀} H / ‖ h \sim \_i ‖ ) ) * h \sim \_g / {‖ h \sim \_g ‖}^{⋀} 2 \qquad [ Equation 13 ]$$

[Equation 13] is a well-known Rayleigh quotient problem, and the optimal value h~g is given by the eigenvector corresponding to the smallest eigenvalue of the matrix A_g=Σ_{i=1,i≠g}/{G}(h~_i/|h~_i|)*(h~_i\hat{ }H/|h~i|). Here, The matrix A_g is composed of a sum of rank-1 matrices, and all eigenvalues are non-negative. Therefore, the eigenvector corresponding to the smallest eigenvalue, which is zero, becomes the optimal value h~g. In this time, defining the eigenvector corresponding to eigenvalue zero as v_null, the optimization problem to find the optimal Φ g may be expressed as [Equation 14].

$$( P 2 ) : max\_ ( Φ\_g ) \vert h \sim \_g \hat{} H * v\_null \vert ⇒ max\_ ( Φ\_g ) \vert h \sim \_d , g \hat{} H * v\_null + φ\_g \hat{} H * diag ( h \sim \_r , g ) * H\_g * v\_null \vert \qquad [ Equation 14 ]$$

[Equation 14] aims to find Φ_g by adjusting the g-th RIS element configuration matrix Φ_g such that the value of approaches as closely as possible to v_null.

The optimal g-th RIS element configuration vector may be represented as shown in the following [Equation 15].

$$Φ\_g {\hat{}}^{*} = e \hat{} ( j ∠ ( v\_null \hat{} H * h \sim \_d , g ) ) \times e \hat{} ( j ∠ ( diag ( h \sim \_r , g ) * H\_g * v\_null ) ) \qquad [ Equation 15 ]$$

In [Equation 15], Φ_g\hat{ }* denotes the optimal g-th RIS element configuration vector, and ≤(a) indicates the phase value of each element of vector a.

The rank of matrix A_g satisfies the relationship rank (A_g)≤G-1<N, enabling obtaining of multiple eigenvectors (v_null) corresponding to the eigenvalue of 0. According to an embodiment of the present disclosure, among multiple eigenvectors and multiple g-th RIS element configuration vectors obtained using these eigenvectors, the eigenvector and the g-th RIS element configuration vector maximizing the objective function of [Equation 14] may be finally selected. According to an embodiment of the present disclosure, the base station may minimize attenuation of intended signals for the UEs of the g-th group by configuring reflection coefficients of the g-th RIS passive elements based on the selected g-th RIS element configuration vector. The reflection coefficients of RIS passive elements may include phase shift values of RIS passive elements.

As described above, according to an embodiment of the present disclosure, the base station may estimate the representative channel of each group as shown in [Equation 2] for multi-group multicast and determine a ZF beamformer as in [Equation 3] based on the representative channel of each group. When the base station employs a ZF beamformer for multi-group multicast, inter-group interference may be alleviated, but the intended signal for each group may be attenuated. Thus, in an embodiment of the present disclosure, the base station may obtain the RIS element configuration matrix for each group representing phase shift values of RIS passive elements based on characteristics of the ZF beamformer, to minimize the attenuation of intended signals for each group caused by ZF. The base station may minimize the attenuation of intended signals for the UEs of each group by configuring reflection coefficients for the passive elements of each RIS based on the obtained RIS element configuration matrix for each group.

FIG. 12 shows a signal flow between a UE and a base station for transmitting and receiving data according to an embodiment of the present disclosure. FIG. 12 illustrates signal flows between a base station (1110), RIS (1120-g), and UEs (1140-g1 to 1140-gK) in a wireless communication system employing multiple RISs as depicted in FIG. 11, in which the base station (1110) supports multi-group multicast. Here, the UEs (1140-g1 to 1140-gK) may belong to the g-th group in FIG. 11, and RIS (1120-g) may be the RIS corresponding to the g-th group.

Referring to FIG. 12, in step S1210, the base station (1110) transmits reference signals to the UEs (1140-g1 to 1140-gK). For example, the base station (1110) may transmit at least one reference signal to UEs (1140-g1 to 1140-gK) belonging to the g-th group using multiple antennas. The at least one reference signal may be transmitted over multiple transmission occasions. The multiple transmission occasions may be determined based on at least one of the number of antenna elements at the base station (1110) and the number of activated reflective surfaces on the RIS. For example, the base station (1110) may repeatedly transmit each of the downlink reference signals, consisting of a first number of orthogonal or quasi-orthogonal sequences, over a second number of transmission occasions. Here, the first number may correspond to the number of antenna elements at the base station, and the second number may correspond to the number of activated reflective surfaces on the RIS. The at least one reference signal transmitted from the base station (1110) may reach UEs (1140-g1 to 1140-gK) either directly or after being reflected by RIS (1120-g).

In step S1220, each of the UEs (1140-g1 to 1140-gK) may transmit feedback information including channel measurement information based on the reference signals to the base station (1110). For example, the k-th UE (1140-gₖ) (gₖ-th UE) in group g may generate channel measurement information for the channel between the base station (1110) and UE (1140-gₖ), and for the channel between RIS (1120-g) and UE (1140-gₖ), based on the reference signals. The channel measurement information may include at least one of channel coefficients corresponding to combinations of antenna elements and reflective surfaces, information indicating channel quality, information indicating the channel environment, and information indicating the time variation of the channel.

In step S1230, the base station (1110) may transmit downlink data based on the feedback information. The base station (1110) may determine transmit beamforming weights based on the received feedback information and apply these beamforming weights to the downlink data. Additionally, the base station (1110) may determine reflection coefficients for reflective surfaces of each RIS based on the received feedback information and transmit the determined reflection coefficients to each RIS. For example, the base station (1110) may estimate a representative channel per group based on [Equation 1] and [Equation 2] and derive a ZF beamformer as shown in [Equation 3]. The base station (1110), based on the ZF beamformer characteristics, may obtain a group-specific RIS element configuration matrix representing phase shifts per group, as in [Equation 15], and transmit it to each RIS before transmitting downlink data. Here, identical data may be transmitted to UEs within the same group, while different data may be transmitted to UEs belonging to different groups.

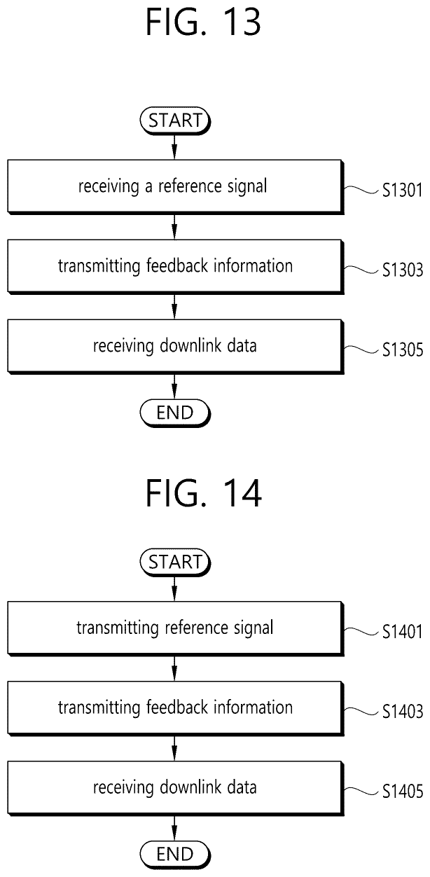

FIG. 13 shows an example of a procedure for receiving data at a UE according to an embodiment of the present disclosure. The UE in FIG. 13 may correspond to the gₖ-th UE (1140-gₖ) in FIG. 11 and FIG. 12.

Referring to FIG. 13, in step S1301, the UE may receive reference signals from the base station. According to an embodiment, the UE may receive configuration information related to channel measurement from the base station, and receive downlink reference signals based on the received configuration information. The configuration information may include, for example, information indicating resources transmitted for reference signals, information related to feedback of measurement results, and information related to sequences of reference signals. Here, the information related to feedback may indicate items for which feedback is required, and the required items may differ according to the operation mode. Thus, information indicating an operation mode may be included in the configuration information, either instead of or in addition to the information related to feedback. The downlink reference signals may be received during multiple transmission occasions. The multiple transmission occasions may be determined based on at least one of the number of antenna elements at the base station and the number of activated reflective surfaces on the RIS. For example, the UE may repeatedly receive each of the downlink reference signals consisting of a first number of orthogonal or quasi-orthogonal sequences during a second number of transmission occasions. Here, the first number may correspond to the number of antenna elements at the base station, and the second number may correspond to the number of activated reflective surfaces on the RIS.

In step S1303, the UE may transmit feedback information to the base station. The feedback information may include channel measurement information generated based on the received reference signals. The step of transmitting feedback information may be the same as step S1220 in FIG. 12.

In step S1305, the UE may receive downlink data. The downlink data may be received by the UE after being transmitted through the base station's ZF beamformer, or may be received after being transmitted through the base station's ZF beamformer and then reflected by the RIS of the group to which the UE belongs. According to an embodiment, the downlink data may be received by the UE after being transmitted from the base station using ZF beamforming weights. According to an embodiment, the downlink data may be received by the UE after being transmitted from the base station using ZF beamforming weights, and subsequently reflected according to the reflection coefficients of the RIS in the g-th group. The downlink data being transmitted using ZF beamforming weights may mean that it is transmitted via a spatial domain transmission filter based on ZF (zero forcing).

FIG. 14 shows an example of a procedure for transmitting data from a base station according to an embodiment of the present disclosure. FIG. 14 may correspond to the base station (1110) in FIG. 11 and FIG. 12.

Referring to FIG. 14, in step S1401, the base station may transmit reference signals. According to an embodiment, the base station may transmit configuration information related to channel measurement and transmit downlink reference signals based on the transmitted configuration information. The configuration information related to channel measurement may include information related to reference signals transmitted for channel measurement. For example, the configuration information may be structured in the same way as described in step S1301 of FIG. 13. Additionally, the downlink reference signals may be transmitted in the same manner as described in step S1210 of FIG. 12.

In step S1403, the base station may receive feedback information from multiple UEs. The feedback information may include channel measurement information generated by each UE based on the reference signals. The channel measurement information may be structured as described in step S1220 of FIG. 12.

In step S1405, the base station may transmit downlink data to multiple UEs based on the feedback information. The base station may transmit downlink data using a multi-group multicast scheme. For example, the base station may multicast downlink data intended for multiple UEs, transmitting identical downlink data to UEs within the same group and transmitting different downlink data to UEs belonging to different groups. The base station may determine ZF beamforming weights for multi-group multicast based on the received feedback information, and apply the ZF beamforming weights to the downlink data. Additionally, the base station may determine reflection coefficients for the reflective surfaces of each of the RISs based on the received feedback information, and transmit the determined reflection coefficients to each RIS. For example, the base station may estimate a representative channel for each group based on [Equation 1] and [Equation 2], and obtain a ZF beamformer such as in [Equation 3] based on the representative channel of each group. When the base station performs multi-group multicast using the ZF beamformer, inter-group interference may be mitigated; however, this method has an issue of signal strength degradation for the intended signal within each group. Thus, to minimize the degradation of the intended signal, the base station may use the NS (Null-Space) technique to derive a group-specific RIS element configuration matrix such as [Eq. 15], based on characteristics inherent to the ZF beamformer. Before transmitting downlink data, the base station may transmit the group-specific RIS element configuration matrix to each RIS, thereby allowing reflection coefficients of passive elements in each RIS to be configured based on the group-specific RIS element configuration matrix. Accordingly, the downlink data transmitted from the base station, after being applied with ZF beamforming weights at the base station, may reach the UEs by being reflected by passive elements of each RIS.

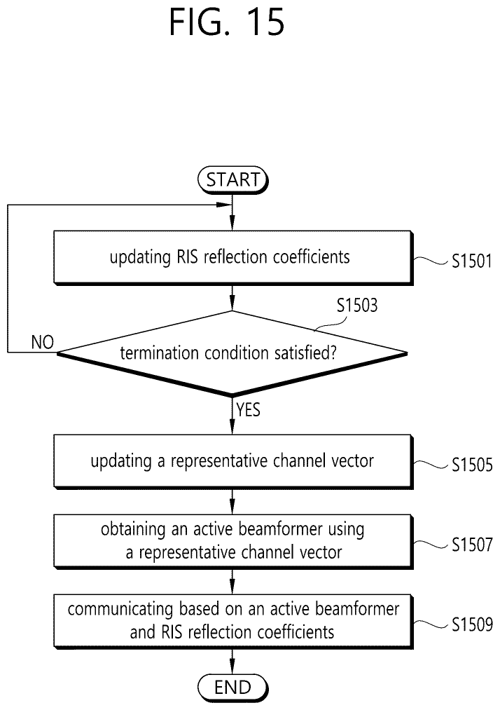

FIG. 15 shows an example of configuring a beamformer and RIS reflection coefficients at a base station according to an embodiment of the present disclosure. At least some operations of FIG. 15 may correspond to detailed operations of step S1230 in FIG. 12 and/or step S1405 in FIG. 14. In FIG. 15, at least some operations may be performed sequentially or in parallel. For example, some operations in FIG. 15 may be performed at least partially at the same point in time.

Referring to FIG. 15, in step S1501, the base station may update reflection coefficients of multiple RISs. According to an embodiment, the base station may update RIS reflection coefficients based on channel information and initial RIS reflection coefficients. The base station may obtain representative channel information for each group based on feedback information received from multiple UEs. For example, the base station may obtain an average channel value of UEs within each group based on channel measurement information received from multiple UEs as in [Equation 2], and determine the obtained average value as the representative channel information for each group. The base station may update reflection coefficients for each of the multiple RISs based on representative channel information of each group and initial RIS reflection coefficients. The reflection coefficients of the RISs may include an RIS element configuration vector indicating the phase shift values of passive elements of the RIS. For example, the base station may determine an RIS element configuration vector that minimizes the intended signal attenuation for each group based on [Equation 5] through [Equation 15].

In step S1503, the base station may determine whether a condition to terminate the RIS reflection coefficient updating operation is satisfied. The condition for terminating the RIS reflection coefficient updating operation may relate to at least one of the number of performed RIS reflection coefficient updates, whether reflection coefficients of multiple RISs have been updated, and whether reflection coefficients of multiple RISs have converged. For example, the base station may determine that the condition to terminate the RIS reflection coefficient updating operation is satisfied if reflection coefficients of multiple RISs no longer change despite repeatedly performing the updating operation. For example, the base station may determine that the termination condition is satisfied when reflection coefficients have been updated for all of the multiple RISs.

If the condition to terminate the RIS reflection coefficient updating operation is not satisfied, the base station may return to step S1501 and re-perform the operation of updating reflection coefficients of the multiple RISs.

If the condition to terminate the RIS reflection coefficient updating operation is satisfied, the base station may update representative channel vectors in step S1505. For example, the base station may update the representative channel for each group based on the updated RIS reflection coefficients. This is because, as shown in [Equation 2], the representative channel of each group is influenced by RIS reflection coefficients, thus representative channels reflecting updated RIS reflection coefficients need to be obtained.

In step S1507, the base station may obtain an active beamformer using updated representative channel vectors. For example, the base station may obtain a ZF beamformer, which is an active beamformer, using representative channel vectors as shown in [Equation 3]. The ZF beamformer may include ZF beamforming weights.

In step S1509, the base station may communicate based on the active beamformer and RIS reflection coefficients. According to an embodiment, the base station may transmit downlink data using a multi-group multicast scheme, applying ZF beamforming weights to the downlink data to be transmitted. Here, before transmitting the downlink data, the base station may transmit reflection coefficients of multiple RISs to each RIS, allowing the reflection coefficients of the multiple RISs to be updated accordingly. Accordingly, the downlink data transmitted from the base station may be reflected by multiple RISs and delivered to UEs within the multiple groups.

As described above, in embodiments of the present disclosure, by performing multi-group multicast using the ZF beamformer, the base station may mitigate inter-group interference and minimize the attenuation of the intended signal strength for each group by adjusting reflection coefficients of the multiple RISs.

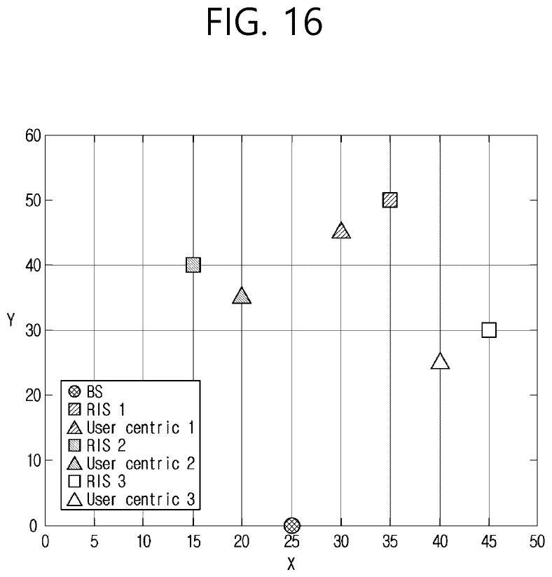

FIG. 16 shows an example of a simulation environment showing positions of a base station, RISs, and UEs according to an embodiment of the present disclosure. Specifically, FIG. 16 shows the base station (BS), RISs (RIS1, RIS2, RIS3) positioned apart from the BS, and the center locations of UEs within each RIS group. Additionally, the simulation environment assumes the BS has N(=2×8) antennas, and each RIS has Mg (=3×8) passive elements arranged in a UPA structure. Additionally, it is assumed there are a total of 3 RISs, each RIS group includes Kg(=6) UEs, and these UEs are located within a radius of 3 m around each RIS.

In the simulation environment shown in FIG. 16, all communication channels are assumed to follow the Rician channel model. Additionally, angles of LoS (line of sight) channels are mathematically calculated based on transmitter and receiver positions, and angles of NLOS (non-line of sight) channels are generated using a Laplacian distribution with a specific variance around the LoS channel angles. The system bandwidth is set to 10 MHz. Path loss exponents for large-scale fading of the channels between RIS and UE, BS and RIS, and BS and UE are assumed to be 2.2, 2.3, and 4.5, respectively. The number of NLOS channels between RIS and UE, between BS and RIS, and between BS and UE are set to 4, 8, and 8 respectively, and the Rician factors for the channels between RIS and UE, BS and RIS, and BS and UE are set to 7, 5, and 3 dB, respectively.

In a multi-group multicast system, all UEs within each group receive the same information. Therefore, each group may transmit and receive data at a transmission rate corresponding to the minimum achievable data rate among UEs within the group, depending on their channel conditions. As the present disclosure considers multi-group multicast, the sum of these minimum achievable data rates may be used as a performance metric. In this case, the achievable data rate of the gₖ-th UE may be expressed as in [Equation 16] below.

$${R\_g}_{k} = log\_ 2 ( 1 + \vert ( h\_d , {g}_{k} \hat{} H + h\_r , {g}_{k} \hat{} H Φ\_g H\_g ) f\_g \vert \hat{} 2 / ( Σ\_ \{ i \neq g \} \hat{} \{ G \} \vert ( h\_d , {g}_{k} \hat{} H + h\_r , {g}_{k} \hat{} H Φ\_g H\_g ) f\_i \vert \hat{} 2 + {σ\_g}_{k} \hat{} 2 ) ) \qquad [ Equation 16 ]$$

In [Equation 16], Rok may represent the achievable data rate of the gₖ-th UE.

In the multi-group multicast system, the sum of data transmission rates may be expressed as in [Equation 17] below.

$$Σ\_ \{ g = 1 \} \hat{} \{ G \} min\_ \{ {g}_{k} ∈ \{ g\_ 1 , … , {g\_K}_{g} \} \} {R\_g}_{k} \qquad [ Equation 17 ]$$

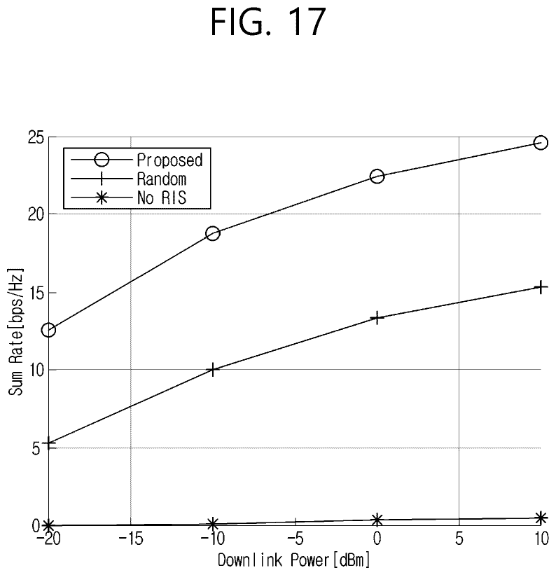

FIG. 17 shows a performance graph showing the sum of UE data rates according to downlink transmit power values at the base station according to an embodiment of the present disclosure. Here, “Proposed” represents the performance graph according to embodiments of the present disclosure as described above, and “No RIS” represents the performance graph for the case of performing ZF beamforming considering only the representative channels without using RIS. Additionally, “Random” represents the performance graph for the case of using RIS for each group, but setting the values of passive elements of the RIS randomly.

Referring to FIG. 17, it may be observed that the sum of data transmission rates of the proposed method (“Proposed”) is higher than those of “Random” and “No RIS”. Additionally, as the downlink transmit power of the base station increases, it may be seen that the difference between the sum of data transmission rates of “Proposed” and that of “Random” or “No RIS” becomes larger.

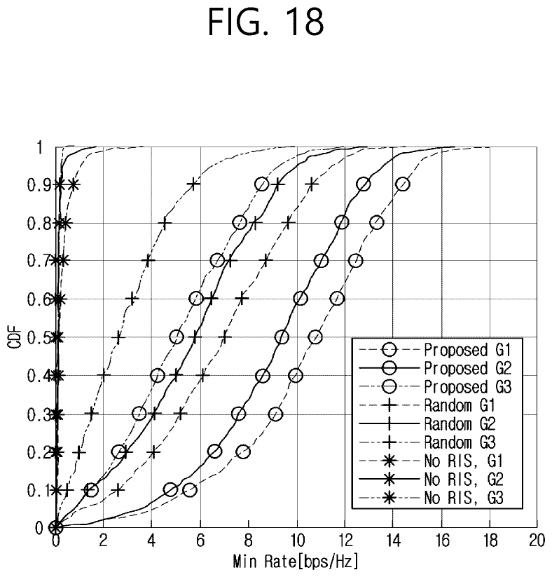

FIG. 18 shows a cumulative distribution function graph of minimum UE data rates according to an embodiment of the present disclosure. Here, “Proposed, G #” represents the performance graph of the #-th group when active and passive beamforming are performed according to the embodiments of the present disclosure, and “No RIS, G #” represents the performance graph of the #-th group for the case of performing ZF beamforming considering only representative channels without using RIS. Additionally, “Random, G #” represents the performance graph of the #-th group for the case of using RIS for each group, but randomly setting the values of passive RIS elements. FIG. 18 shows a cumulative distribution function graph of minimum UE data rates according to an embodiment of the present disclosure.

Referring to FIG. 18, it may be observed that the Min Rate per group of “Proposed” is higher than that of “Random” and “No RIS”. Here, “Min Rate” may represent the minimum data rate among UEs within each group.

As described above, the embodiment of the present disclosure proposed a method for performing multi-group multicast by operating multiple RISs. Specifically, the embodiment proposed performing ZF beamforming at the base station based on representative channels per group, and performing passive beamforming by controlling RIS reflection coefficients based on channels expressed through the NS (null-space) technique. According to the embodiments of the present disclosure, inter-group interference that may occur due to multi-group multicast may be mitigated through ZF beamforming at the base station. Additionally, by controlling RIS reflection coefficients based on channels expressed using the NS technique, the embodiments of the present disclosure may minimize attenuation of intended signals for UEs within each group. Such an approach may have the advantage of low complexity by utilizing relatively simple linear algebraic methods instead of complicated optimization techniques.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method for operating a user equipment (UE), the method comprising:
receiving, from a base station, at least one reference signal;
transmitting, to the base station, feedback information based on the at least one reference signal; and
receiving, from the base station, downlink data,
wherein the downlink data is transmitted based on a spatial domain transmission filter, and received by the UE after being reflected by a first Reconfigurable Intelligent Surface (RIS) among a plurality of RISs,
wherein each of the plurality of RISs assists signal transmission of each of a plurality of groups including a plurality of UEs.

2. The method of claim 1,
wherein the spatial domain transmission filter is determined based on representative channel information of each of the plurality of groups.

3. The method of claim 2,
wherein representative channel information of a first group among the plurality of groups is estimated based on an average value of channels of UEs included in the first group, and
wherein the feedback information includes channel information of the UE estimated based on the reference signal.

4. The method of claim 2,
wherein the spatial domain transmission filter includes a spatial domain transmission filter based on zero forcing (ZF).

5. The method of claim 2,
wherein the downlink data is reflected by a reflection coefficient of the first RIS, and
wherein reflection coefficients of the plurality of RISs are updated based on the representative channels of each of the plurality of groups and initial reflection coefficients for the plurality of RISs.

6. The method of claim 5,
wherein the reflection coefficients of the plurality of RISs include phase shift values of passive elements included in each of the plurality of RISs.

7. The method of claim 5,
wherein the reflection coefficients of the plurality of RISs are determined by an RIS element configuration matrix minimizing intended signal attenuation for each of the plurality of groups, and
wherein the intended signal attenuation is represented by a channel vector based on a Neumann Series (NS) technique.

8. The method of claim 7,
wherein the representative channels of each of the plurality of groups are updated by the determined reflection coefficients of the plurality of RISs, and
wherein the spatial domain transmission filter based on zero forcing (ZF) is determined based on the updated representative channels of each of the plurality of groups.

9. A method for operating a base station, the method comprising:
transmitting, to at least one user equipment (UE), at least one reference signal;
receiving, from the at least one UE, feedback information based on the at least one reference signal; and
transmitting, to the at least one UE, downlink data,
wherein the downlink data is transmitted based on a spatial domain transmission filter, and received by the at least one UE after being reflected by a first Reconfigurable Intelligent Surface (RIS) among a plurality of RISs,
wherein each of the plurality of RISs assists signal transmission of each of a plurality of groups including a plurality of UEs.

10. The method of claim 9,
wherein the spatial domain transmission filter is determined based on representative channel information of each of the plurality of groups.

11. The method of claim 10,
wherein representative channel information of a first group among the plurality of groups is estimated based on an average value of channels of UEs included in the first group, and
wherein the feedback information includes channel information of the UE estimated based on the reference signal.

12. The method of claim 10,
wherein the spatial domain transmission filter includes a spatial domain transmission filter based on zero forcing (ZF).

13. The method of claim 10,
wherein the downlink data is reflected by a reflection coefficient of the first RIS, and
wherein reflection coefficients of the plurality of RISs are updated based on the representative channels of each of the plurality of groups and initial reflection coefficients for the plurality of RISs.

14. The method of claim 13,
wherein the reflection coefficients of the plurality of RISs include phase shift values of passive elements included in each of the plurality of RISs.

15. The method of claim 13,
wherein the reflection coefficients of the plurality of RISs are determined by an RIS element configuration matrix minimizing intended signal attenuation for each of the plurality of groups, and
wherein the intended signal attenuation is represented by a channel vector based on a Neumann Series (NS) technique.

16. The method of claim 15,
wherein the representative channels of each of the plurality of groups are updated by the determined reflection coefficients of the plurality of RISs, and
wherein the spatial domain transmission filter based on zero forcing (ZF) is determined based on the updated representative channels of each of the plurality of groups.

17. A user equipment (UE) comprising:
a transceiver; and
a processor connected to the transceiver,
wherein the processor is configured to perform operations comprising:
receiving, from a base station, at least one reference signal;
transmitting, to the base station, feedback information based on the at least one reference signal; and
receiving, from the base station, downlink data,
wherein the downlink data is transmitted based on a spatial domain transmission filter, and received by the UE after being reflected by a first Reconfigurable Intelligent Surface (RIS) among a plurality of RISs,
wherein each of the plurality of RISs assists signal transmission of each of a plurality of groups including a plurality of UEs.

18-20. (canceled)

21. The method of claim 17,
wherein the spatial domain transmission filter is determined based on representative channel information of each of the plurality of groups.

22. The method of claim 18,
wherein representative channel information of a first group among the plurality of groups is estimated based on an average value of channels of UEs included in the first group, and
wherein the feedback information includes channel information of the UE estimated based on the reference signal.

23. The method of claim 18,
wherein the spatial domain transmission filter includes a spatial domain transmission filter based on zero forcing (ZF).
